(19) United States
(12) Patent Application Publication
(10) Pub. No.: US 2026/0366544 A1
(43) Pub. Date: Nov. 19, 2026

(54) ANTI-MISOPERATION DETACHABLE CONNECTOR AND CONNECTOR ASSEMBLY

(71) Applicant: SHENZHEN LEQI INNOVATION CO., LTD., SHENZHEN (CN)

(72) Inventor: YAXIONG YAN, SHENZHEN (CN)

(21) Appl. No.: 19/654,496

(22) Filed: Apr. 22, 2026

(30) Foreign Application Priority Data
May 14, 2025 (CN) 202520956441.2

(51) Int. Cl. F16B 1/04; F16B 2/04

(52) U.S. Cl. CPC F16B 1/04; F16B 2/04

(57) ABSTRACT

An anti-misoperation detachable connector for connecting photographic equipment is provided. The anti-misoperation detachable connector includes a housing defining a sliding cavity therein, an inner shaft slidably disposed within the sliding cavity, a main unlocking mechanism, a restriction-releasing mechanism, and a restriction mechanism. An end of the housing in an axial direction of the housing is provided with an insertion portion for connecting photographic equipment, and a locking member is provided through a sidewall of the insertion portion. The inner shaft moves to either press against the locking member or release the locking member. The main unlocking mechanism presses the inner shaft to move for releasing the locking member. The restriction mechanism prevents the inner shaft from moving when not actuated by the restriction-releasing mechanism, and to allow the inner shaft to move when actuated by the restriction-releasing mechanism.

### TECHNICAL FIELD

The present disclosure relates to the technical field of photographic equipment, and in particular to an anti-misoperation detachable connector and a connector assembly.

### BACKGROUND

In the field of photographic equipment, quick detach connectors are widely used for connecting camera straps to cameras due to their excellent fastening strength and durability, particularly their outstanding performance in cold environments. In actual shooting, photographers often need to quickly connect a camera to a strap or detach/install it at any time. The quick detach connectors greatly enhances the convenience of this process, effectively meeting photographers'demands for operational efficiency.

The mainstream quick detach connectors available on the market are mostly of a button-type design, provided with two buttons that share the same function. Both buttons unlock the connector from its socket by pressing to move a shaft inside the connector.

However, this design has obvious drawbacks. Since both buttons have the same function, accidental actuation of a single button caused by external forces, such as snagging on clothing or other unintended contact, may trigger movement of the shaft, leading to unintended unlocking of the connector. As a precision and valuable device, if the camera falls off the camera strap due to unintended unlocking, the consequences may be severe, including damaged housing, loosened or damaged internal components, and the like. This not only disrupts the shooting process but also imposes high repair costs for the photographer.

### SUMMARY

The present disclosure provides an anti-misoperation detachable connector, aiming to address the issues in related art that connectors are prone to unintended unlocking due to accidental actuation.

To realize the above objective, the present disclosure provides an anti-misoperation detachable connector, configured for connecting photographic equipment. The anti-misoperation detachable connector includes a housing, an inner shaft, a main unlocking mechanism, and a safety locking mechanism.

The housing defines a sliding cavity therein, an end of the housing in an axial direction of the housing is provided with an insertion portion for connecting the photographic equipment, and a locking member is provided through a sidewall of the insertion portion.

The inner shaft is slidably disposed within the sliding cavity, and the inner shaft is configured to move to either press against the locking member or release the locking member.

The main unlocking mechanism is movably disposed through a sidewall of the housing, and the main unlocking mechanism is configured to press the inner shaft to move for releasing the locking member.

The safety locking mechanism includes a restriction-releasing mechanism and a restriction mechanism.

The restriction-releasing mechanism is movably disposed through the sidewall of the housing and spaced apart from the main unlocking mechanism.

The restriction mechanism is configured to prevent the inner shaft from moving when not actuated by the restriction-releasing mechanism, and to allow the inner shaft to move when actuated by the restriction-releasing mechanism.

In some embodiments, the restriction mechanism includes a restriction member movably disposed on the inner shaft or movably disposed on the housing; and a first reset member, configured to act on the restriction member. The restriction member moves on its movement path having a restriction position. The restriction member prevents the inner shaft from moving when the restriction member is in the restriction position, and the restriction member is capable of moving away from the restriction position when actuated by the restriction-releasing mechanism. The first reset member is configured to provide a force to the restriction member to reset the restriction member to the restriction position.

In some embodiments, the sidewall of the housing is defined with a first mounting hole communicated with the sliding cavity, and the restriction-releasing mechanism is mounted in the first mounting hole. The restriction member is a stop pin, a sidewall of the inner shaft is defined with a sliding hole, and the stop pin is slidably fitted in the sliding hole to be movable relative to the inner shaft. The first reset member is a first spring accommodated in the sliding hole and configured to act on the stop pin. The stop pin extends into the first mounting hole under an elastic force of the first spring to reach the restriction position, or the stop pin retracts from the first mounting hole by being pressed by the restriction-releasing mechanism to leave the restriction position.

In some embodiments, the sidewall of the housing is defined with a second mounting hole communicated with the sliding cavity, and the main unlocking mechanism is mounted in the second mounting hole. An end of the main unlocking mechanism extends into the sliding cavity and is provided with a pressing inclined surface, and a sidewall of the inner shaft is provided with a pressed inclined surface, wherein the pressed inclined surface forms a contact fit with the pressing inclined surface. The housing is provided with a second reset member configured to provide a force to the inner shaft to reset the inner shaft.

In some embodiments, the inner shaft is defined with an accommodation hole; and the second reset member is a second spring. An end of the second spring abuts against a wall of the sliding cavity, and another end of the second spring extends into the accommodation hole and abuts against a bottom wall of the accommodation hole.

In some embodiments, the housing includes a first housing and a second housing detachably connected to the first housing. The first housing defines a first cavity, the second housing defines a second cavity, and the first cavity and the second cavity cooperatively define the sliding cavity. The main unlocking mechanism and the restriction-releasing mechanism are disposed on the first housing, and the insertion portion is arranged on the second housing.

In some embodiments, at least one selected from a group consisting of the restriction-releasing mechanism and the main unlocking mechanism defines a limiting groove; and an end of the second housing is inserted into the first housing and is provided with a limiting portion extending into the limiting groove. Two groove walls defining the limiting groove match with the limiting portion to limit a travel range of the restriction-releasing mechanism and/or the main unlocking mechanism that defines the limiting groove.

In some embodiments, the restriction-releasing mechanism and the main unlocking mechanism are arranged opposite on a circumferential side of the housing.

In some embodiments, the locking member includes a plurality of ball detents that are arranged at intervals along a circumferential direction of the insertion portion; and an end of the inner shaft is provided with a pressing truncated cone, and a side surface of the pressing truncated cone forms a contact fit with the plurality of ball detents.

The present disclosure further provides connector assembly, including a connecting connector and the anti-misoperation detachable connector of any of the foregoing embodiments. The connecting connector is configured to connect photographic equipment, and the anti-misoperation detachable connector is configured to be plugged into and locked with the connecting connector.

According to the present disclosure, the anti-misoperation detachable connector employs an independent main unlocking mechanism and a safety locking mechanism, forming a two-button unlocking mechanism. In the locked state, the restriction mechanism is not actuated by the restriction-releasing mechanism and therefore restricts movement of the inner shaft, i.e., prevents the inner shaft from moving. Thus, even if either the main unlocking mechanism or the restriction-releasing mechanism is accidentally triggered by external force (e.g., snagging on clothing or inadvertent contact), the inner shaft remains immovable and the locking member will not be released, thereby effectively preventing unintended unlocking of the anti-misoperation detachable connector. Unlocking can only be achieved by pressing the restriction-releasing mechanism first to actuate the restriction mechanism, thereby allowing the inner shaft to move, and then operating the main unlocking mechanism to press the inner shaft to release the locking member. This two-button unlocking mechanism reduces the risk of unintended unlocking. Moreover, this design does not affect normal quick connection and detachment operations. While meeting the requirement for operational convenience, it significantly enhances the safety and stability of the connection for photographic equipment, and reduces the risk of equipment damage and maintenance costs caused by unintended unlocking, thus providing photographers with a more reliable user experience.

### BRIEF DESCRIPTION OF THE DRAWINGS

FIG. 1 is a schematic structural diagram of an anti-misoperation detachable connector according to an embodiment of the present disclosure.

FIG. 2 is a schematic structural diagram of the anti-misoperation detachable connector in FIG. 1 from another perspective.

FIG. 3 is a cross-sectional view of the anti-misoperation detachable connector taken along line A-A in FIG. 2.

FIG. 4 is an exploded view of the anti-misoperation detachable connector in FIG. 1.

FIG. 5 is a schematic diagram of a connector assembly and a piece of photographic equipment according to an embodiment of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

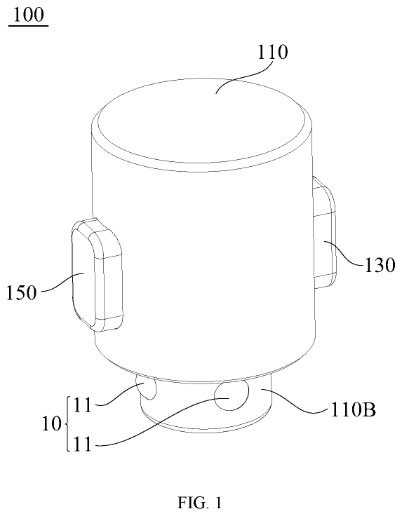

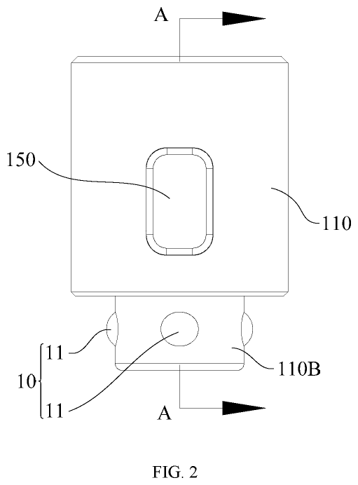

The present disclosure provides an anti-misoperation detachable connector 100 configured to connect photographic equipment. With reference to FIG. 1 to FIG. 3, the anti-misoperation detachable connector 100 includes a housing 110, an inner shaft 120, a main unlocking mechanism 130, and a safety locking mechanism.

The housing 110 defines a sliding cavity 110Q therein. An end of the housing 110 in an axial direction of the housing 110 is provided with an insertion portion 110B configured to connect with the photographic equipment. A locking member 10 is provided through a sidewall of the insertion portion 110B.

The inner shaft 120 is slidably disposed within the sliding cavity 110Q, and is configured to move to either press against or release the locking member 10.

The main unlocking mechanism 130 is movably disposed through a sidewall of the housing 110, and is configured to press the inner shaft 120 to move for releasing the locking member 10.

The safety locking mechanism includes a restriction mechanism 140 and a restriction-releasing mechanism 150.

The restriction-releasing mechanism 150 is movably disposed through the sidewall of the housing 110 and spaced apart from the main unlocking mechanism 130.

The restriction mechanism 140 is configured to prevent the inner shaft 120 from moving when not actuated by the restriction-releasing mechanism 150, and is configured to allow the inner shaft 120 to move when actuated by the restriction-releasing mechanism 150.

In the embodiments, as shown in FIG. 1 to FIG. 3, the housing 110 is configured in a cylindrical shape. The housing 110 defines the sliding cavity 110Q therein, and the sliding cavity 110Q has a diameter dimensioned to accommodate the inner shaft 120. The inner wall of the sliding cavity 110Q is machined to achieve a low surface roughness so as to reduce friction during sliding of the inner shaft 120. One end of the housing 110 in the axial direction thereof is provided with the insertion portion 110B for connecting the photographic equipment. The insertion portion 110B has a diameter smaller than that of the housing 110 and is configured in a stepped shape to facilitate insertion into a socket of the photographic equipment. The sidewall of the insertion portion 110B is defined with a mounting hole for receiving the locking member 10. The housing 110 provides structural support and protection for the entire anti-misoperation detachable connector 100, the sliding cavity 110Q provides space for the sliding of the inner shaft 120, the insertion portion 110B cooperates with the photographic equipment to achieve connection, and the locking member 10 provides a locking function.

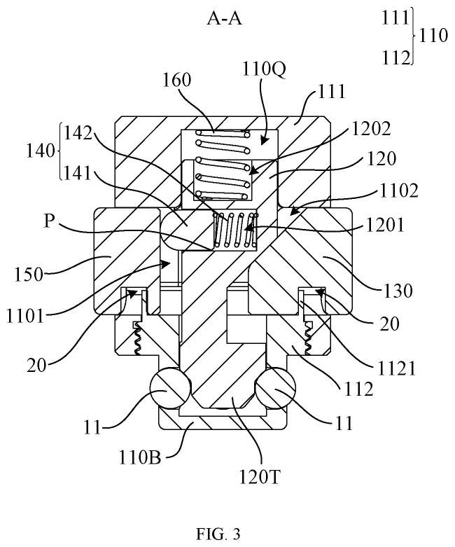

As shown in FIG. 3, the inner shaft 120 is configured in a substantially cylindrical shape, with its outer diameter that matches the inner diameter of the sliding cavity 110Q, such that the inner shaft 120 can slide smoothly within the sliding cavity 110Q without excessive wobble. In some embodiments, an end of the inner shaft 120 is provided with an inclined surface for engaging with the locking member 10. In some embodiments, the inclined surface is provided at an angle of 30 degrees. As the inner shaft 120 moves within the sliding cavity 110Q, the inclined surface either presses against the locking member 10 or releases the locking member 10. The inner shaft 120 thus serves as the actuating member for effecting locking or unlocking the anti-misoperation detachable connector 100 and the photographic equipment. The photographic equipment may be a photographic device such as a camera, or a photographic auxiliary device used to assist a photographic device in capturing images, which is not limited herein.

In some embodiments, the main unlocking mechanism 130 is a main unlocking button made of an engineering plastic material, providing good tactile feel and durability. The main unlocking mechanism 130 is movably disposed through the sidewall of the housing 110, with an end extending into the sliding cavity 110Q and contacting the inner shaft 120. When the main unlocking mechanism 130 is pressed, the main unlocking mechanism 130 converts the applied pressure into a force that drives the inner shaft 120 to slide, thereby allowing the inner shaft 120 to release the locking member 10.

The safety locking mechanism includes the restriction mechanism 140 and the restriction-releasing mechanism 150.

The restriction mechanism 140 is configured to impose or release a restriction on the movement of the inner shaft 120, for ensuring that the anti-misoperation detachable connector 100 is not inadvertently unlocked. When the restriction mechanism 140 establishes a restriction on the movement of the inner shaft 120, the inner shaft 120 is in an immovable state, for example, pressing the main unlocking mechanism 130 will not drive the inner shaft 120 to move. When the restriction mechanism 140 releases the restriction on the movement of the inner shaft 120, the inner shaft 120 is in a movable state, for example, the inner shaft 120 can be moved under the pressing action of the main unlocking mechanism 130.

The restriction mechanism 140 can be various configurations. For example, the restriction mechanism 140 includes a restriction post and a restriction spring. A restriction hole is defined in the sidewall of the housing 110 and is communicated with the sliding cavity 110Q. The restriction post is slidably disposed within the restriction hole. The restriction spring is disposed within the restriction hole, with an end abutting against the restriction post and another end abutting against a bottom of the restriction hole. In a normal state, i.e., the inner shaft 120 is in the immovable state, the restriction spring pushes the restriction post into a restriction groove defined in the inner shaft 120, thereby limiting the movement of the inner shaft 120.

In some embodiments, the restriction-releasing mechanism 150 is a restriction-releasing button configured to act on the restriction mechanism 140. The restriction-releasing mechanism 150 is configured to drive the restriction mechanism 140 to remove the restriction on the movement of the inner shaft 120. When not actuated by the restriction-releasing mechanism 150, the restriction mechanism 140 prevents the inner shaft 120 from moving; when actuated by the restriction-releasing mechanism 150, the restriction mechanism 140 allows the inner shaft 120 to move. In some embodiments, the restriction-releasing mechanism 150 is disposed opposite to the restriction post. An inner side surface of the main unlocking mechanism 130 is provided with a push rod portion, and a side surface of the restriction post is provided with a driving protrusion. The push rod portion is disposed opposite to the driving protrusion along a lateral side of the inner shaft 120. When the user presses the main unlocking mechanism 130, the push rod portion thereof contacts and presses the driving protrusion to drive the restriction post to move, causing the restriction post to retract into the restriction hole and withdraw from the restriction groove of the inner shaft 120, releasing the restriction on the movement of the inner shaft 120. At the same time, the restriction spring accumulates elastic potential energy. When the user releases the main unlocking mechanism 130 and the restriction post aligns with the restriction groove of the inner shaft 120, the restriction post is inserted into the restriction groove under the elastic force of the restriction spring, establishing a restriction on the movement of the inner shaft 120.

The above embodiments are merely exemplary. In addition, other embodiments will be further described below.

According to the embodiments, the anti-misoperation detachable connector 100 employs an independent main unlocking mechanism and a safety locking mechanism, forming a two-button unlocking mechanism. In the locked state, the restriction mechanism 140 is not actuated by the restriction-releasing mechanism 150 and therefore restricts movement of the inner shaft 120, i.e., prevents the inner shaft 120 from moving. Thus, even if the main unlocking mechanism 130 or the restriction-releasing mechanism 150 is accidentally triggered by external force (e.g., snagging on clothing or inadvertent contact), the inner shaft 120 remains immovable and the locking member 10 will not be released, thereby effectively preventing unintended unlocking of the anti-misoperation detachable connector 100. Unlocking can only be achieved by first pressing the restriction-releasing mechanism 150 to actuate the restriction mechanism 140, thereby allowing the inner shaft to move, and then operating the main unlocking mechanism to press the inner shaft 120 to release the locking member 10. This two-button unlocking mechanism reduces the risk of unintended unlocking.

Moreover, the two-button unlocking mechanism does not interfere with the normal quick connection and detachment operations. While maintaining operational convenience, it significantly enhances the safety and stability of the connection of photographic equipment, reduces the risk of equipment damage and maintenance costs caused by unintended unlocking, and provides photographers with a more reliable use experience.

In some embodiments, referring to FIG. 3, the restriction mechanism 140 includes a restriction member 141 movably disposed on either the inner shaft 120 or the housing 110, and a first reset member 142 configured to act on the restriction member 141.

The restriction member 141 has a restriction position P on its movement path. When the restriction member 141 is in the restriction position P, the restriction member 141 prevents the movement of the inner shaft 120. When actuated by the restriction-releasing mechanism 150, the restriction member 141 is capable of moving away from the restriction position P. The first reset member 142 is configured to provide a force to the restriction member 141 to reset the restriction member 141 to the restriction position P.

In the embodiments, the design of the restriction mechanism 140 including the restriction member 141 and the first reset member 142 enhances the reliability and stability of movement restriction. The restriction member 141 is movably disposed on either the inner shaft 120 or the housing 110. In the configuration that the restriction member 141 is disposed on the inner shaft 120, the restriction member 141 is slidably connected to the inner shaft 120 via a sliding hole to ensure the movement of the restriction member 141 along a predetermined direction. In the configuration that the restriction member 141 is disposed on the housing 110, the restriction member 141 is movably mounted through a guiding hole with a smooth inner wall, reducing resistance to the movement of the restriction member 141. The restriction member 141 has the restriction position P on its movement path. When the restriction member 141 is in the restriction position P, it prevents the inner shaft 120 from moving, effectively restricting the movement of the inner shaft 120. This prevents displacement of the inner shaft 120 that could otherwise cause accidental unlocking of the anti-misoperation detachable connector 100 when the main unlocking mechanism 130 is inadvertently triggered.

The first reset member 142 acts on the restriction member 141. In some embodiments, the first reset member 142 is an elastic element such as a spring, an elastic rubber, or the like. The first reset member 142 is configured to provide a force to the restriction member 141 to reset the restriction member 141 to the restriction position P, thereby ensuring that the restriction member 141 remains in the restriction position P when no external force is applied, and maintain the inner shaft 120 in the immovable state.

In cooperation with the restriction mechanism 140, the restriction-releasing mechanism 150 is movably disposed through the sidewall of the housing 110, and an end of the restriction-releasing mechanism 150 is in contact with the restriction member 141. When the restriction-releasing mechanism 150 is pressed, the restriction-releasing mechanism 150 drives the restriction member 141 to move away from the restriction position, thereby releasing the restriction on the movement of the inner shaft 120. Then, operating the main unlocking mechanism 130 can unlock the anti-misoperation detachable connector 100 from the photographic equipment.

In the embodiments, the anti-misoperation unlocking capability of the anti-misoperation detachable connector 100 is enhanced through the coordinated interaction of the restriction member 141, the first reset member 142, and the restriction-releasing mechanism 150. When the restriction member 141 is in the restriction position P where it stop the movement of the inner shaft 120, it provides a safety barrier for the connector, greatly reducing the risk of unintended unlocking caused by accidental force applied to the main unlocking mechanism 130. In addition, the first reset member 142 enables the restriction member 141 to reset automatically, reducing the number of operational steps required, improving convenience and smoothness of use, thereby providing photographers with a more reliable and efficient user experience across various shooting scenarios.

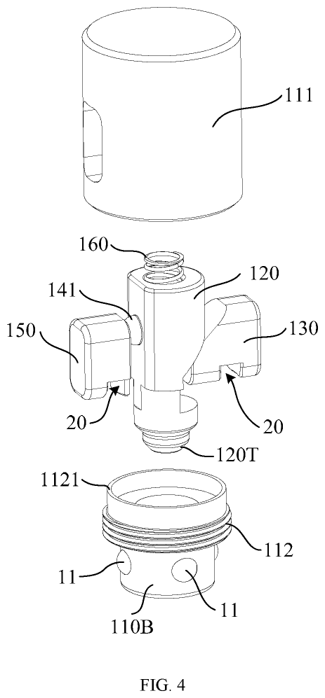

In some embodiments, referring to FIG. 3 and FIG. 4, the sidewall of the housing 110 is defined with a first mounting hole 1101 communicated with the sliding cavity 110Q, and the restriction-releasing mechanism 150 is installed in the first mounting hole 1101.

The restriction member 141 is a stop pin. The sidewall of the inner shaft 120 is defined with a sliding hole 1201. The stop pin is slidably received in the sliding hole 1201 so as to be movable relative to the inner shaft 120. The first reset member 142 is a first spring accommodated in the sliding hole 1201 and acts on the stop pin.

The stop pin extends into the first mounting hole 1101 under the elastic force of the first spring to reach the restriction position P, or is retracted from the first mounting hole 1101 by being pressed by the restriction-releasing mechanism 150 to leave the restriction position P.

In the embodiments, the first mounting hole 1101 is defined in the sidewall of the housing 110 and communicated with the sliding cavity 110Q, providing an installation position for the restriction-releasing mechanism 150. The restriction-releasing mechanism 150 is installed in the first mounting hole 1101 via an interference fit, ensuring that the restriction-releasing mechanism 150 does not easily loosen during use while still being able to smoothly move. The restriction member 141 is a stop pin, and the sliding hole 1201 is defined in the sidewall of the inner shaft 120. A clearance fit is provided between the stop pin and the sliding hole 1201 of the inner shaft 120, such that the stop pin slides smoothly within the sliding hole 1201, allowing it to be movable relative to the inner shaft 120. The first reset member 142 is a first spring accommodated within the sliding hole 1201, with an end abutting against the bottom of the sliding hole 1201 and another end contacting the stop pin. The first spring generates an elastic force through its own elastic deformation to continuously act on the stop pin.

In the normal state, under the elastic force of the first spring, the stop pin extends outward along the axial direction of the sliding hole 1201 until it projects into the first mounting hole 1101, at which point the stop pin reaches the restriction position P. When the stop pin is in the restriction position P, the portion of the stop pin extending into the first mounting hole 1101 engages with the wall of the first mounting hole 1101 to form a stop against the movement of the inner shaft 120, thereby effectively restricting sliding of the inner shaft 120 within the sliding cavity 110Q. Even if the main unlocking mechanism 130 is inadvertently triggered by an external force, the inner shaft 120 remains immovable, thus preventing the locking member 10 from disengaging and avoiding unintended unlocking. When unlocking is required, the restriction-releasing mechanism 150 is pressed. The end of the restriction-releasing mechanism 150 contacts the stopper pin and applies pressure to it. Under this pressure, the stopper pin overcomes the elastic force of the first spring, slides inward along the sliding hole 1201, and withdraws from the first mounting hole 1101, thereby leaving the restriction position P and releasing the restriction on the movement of the inner shaft 120. Then, by operating the main unlocking mechanism 130, the anti-misoperation detachable connector 100 can be smoothly unlocked and disconnected from the photographic equipment.

In the embodiments, the clearance fit between the stop pin and the sliding hole 1201, the interference fit between the restriction-releasing mechanism 150 and the first mounting hole 1101, and the configuration of the first spring, cooperatively ensure stable engagement among the members of the restriction mechanism 140. This allows the restriction mechanism 140 to maintain reliable operational performance over prolonged use. Wear between members is minimized, and issues such as loosening or jamming are unlikely to occur, thereby extending the overall service life of the anti-misoperation detachable connector 100. As a result, the frequency of maintenance and replacement is reduced, providing users with a more reliable and durable experience. The anti-misoperation detachable connector 100 can be performed stably in various photographic scenarios, ensuring smooth operation.

In some embodiments, referring to FIG. 3 and FIG. 4, the sidewall of the housing 110 is further defined with a second mounting hole 1102 communicated with the sliding cavity 110Q, and the main unlocking mechanism 130 is installed in the second mounting hole 1102.

An end of the main unlocking mechanism 130 extends into the sliding cavity 110Q and is provided with a pressing inclined surface. The sidewall of the inner shaft 120 is provided with a pressed inclined surface. The pressed inclined surface and the pressing inclined surface form a contact fit.

A second reset member 160 is provided on the housing 110 and is configured to provide a force to the inner shaft 120 to reset the inner shaft 120.

In the embodiments, the second mounting hole 1102 is defined in the sidewall of the housing 110 and communicated with the sliding cavity 110Q, and the main unlocking mechanism 130 is installed in the second mounting hole 1102, ensuring that the main unlocking mechanism 130 moves smoothly within the second mounting hole 1102 without wobbling or loosening.

One end of the main unlocking mechanism 130 extends into the sliding cavity 110Q and is provided with the pressing inclined surface. The pressing inclined surface is provided with an angle carefully designed to ensure efficient transmission of force during operation. The sidewall of the inner shaft 120 is correspondingly provided with the pressed inclined surface, which forms a contact fit with the pressing inclined surface. When the main unlocking mechanism 130 is pressed, the pressing inclined surface and the pressed inclined surface interact with each other, converting the pressing force applied to the main unlocking mechanism 130 into a force that drives the movement of the inner shaft 120.

Additionally, the second reset member 160 is disposed on the housing 110. In some embodiments, the second reset member 160 is an elastic element such as a spring or an elastic rubber sheet, with an end fixed to the housing 110 and another end connected to or in contact with the inner shaft 120, so as to provide a force for resetting the inner shaft 120. After an unlocking operation is completed, the second reset member 160 automatically resets the inner shaft 120 to its initial position. In this way, a stable and efficient transmission mechanism is formed between the main unlocking mechanism 130 and the inner shaft 120, which, together with the restriction mechanism 140, the restriction-releasing mechanism 150, and the locking member 10, collectively constitutes a complete connection and unlocking system of the anti-misoperation detachable connector 100.

In the embodiments, the engagement between the pressing inclined surface of the main unlocking mechanism 130 and the pressed inclined surface of the inner shaft 120 efficiently converts the pressing force into a moving force for the inner shaft 120, making the unlocking operation easier and requiring less effort. Simply pressing the main unlocking mechanism 130 can achieve the movement of the inner shaft 120 and the unlocking of the locking member 10. The operation process is concise, conforms to ergonomic design, which effectively enhances the user experience and meets the demand for quick connection and disconnection of equipment.

In some embodiments, referring to FIG. 3 and FIG. 4, the inner shaft 120 is defined with an accommodation hole 1202. The second reset member 160 is a second spring. An end of the second spring abuts against a wall of the sliding cavity 110Q, and another end of the second spring extends into the accommodation hole 1202 and abuts against a bottom wall of the accommodation hole 1202.

In the embodiments, the shape and size of the accommodation hole 1202 are designed according to the specifications of the second reset member 160, providing a stable installation space for the second reset member 160. The second reset member 160 employs a second spring, which is accommodated within the accommodation hole 1202. One end of the second spring abuts against the wall of the sliding cavity 110Q, and the other end of the second spring contacts the bottom wall of the accommodation hole 1202 of the inner shaft 120. Through its own elastic deformation, the second spring generates an elastic force that continuously acts on the inner shaft 120 to provide a resetting force for the inner shaft 120.

The accommodation hole 1202 within the housing 110 provides precise installation positioning for the second spring, allowing the second spring to maintain a stable force direction and compression state during operation. This prevents the second spring from deviating or twisting during use, effectively enhancing the stability. Meanwhile, the close fit between the second spring and the inner shaft 120, combined with the inclined surface transmission structures of the main unlocking mechanism 130 and the inner shaft 120, establishes a stable mechanical system in which the members cooperate and constrain one another. This reduces wobbling and loosening between components, further enhances the overall structural reliability of the anti-misoperation detachable connector 100, and maintains good working performance under various complex operating conditions.

In some embodiments, referring to FIG. 3 and FIG. 4, the housing 110 includes a first housing 111 and a second housing 112 detachably connected to the first housing 111. The first housing 111 defines a first cavity, and the second housing 112 defines a second cavity.

The first cavity and the second cavity cooperatively define the sliding cavity 110Q.

The main unlocking mechanism 130 and the restriction-releasing mechanism 150 are disposed on the first housing 111, and the insertion portion 110B is provided on the second housing 112.

In the embodiments, the housing 110 employs a split-type design, including the first housing 111 and the second housing 112. The first housing 111 defines the first cavity, and the second housing 112 defines the second cavity. The first housing 111 and the second housing 112 are each provided with a connecting portion, where the two connecting portions are provided with mutually matching snap-fit structures or threaded structures, ensuring a stable connection while facilitating disassembly. After the second housing 112 is connected to the first housing 111, the first cavity and the second cavity are aligned and joined together, forming the sliding cavity 110Q for accommodating the inner shaft 120 and allowing the inner shaft 120 to slide therein.

The main unlocking mechanism 130 and the restriction-releasing mechanism 150 are disposed on the first housing 111. The mounting holes communicated with the sliding cavity 110Q are defined in the first housing 111 for installing the main unlocking mechanism 130 and the restriction-releasing mechanism 150, so that the two mechanisms can move smoothly and effectively cooperate with the inner shaft 120. The insertion portion 110B is provided on the second housing 112, and the sidewall of the insertion portion 110B is defined with the mounting hole for installing the locking member 10.

Such configuration of the housing 110 allows the first housing 111 and the second housing 112 to be manufactured separately, simplifying the production process, reducing production difficulty, and lowering costs. Moreover, the two housings can be fabricated using different processing methods and materials according to functional requirements. For example, the first housing 111 is made of a material that facilitates button installation, while the second housing 112 is made of a material with higher strength and better wear resistance for forming the insertion portion 110B, thereby improving production flexibility and efficiency. Additionally, this configuration facilitates assembly, allowing quick completion of the assembly of various members through automated equipment or manual labor, thereby enhancing production efficiency.

In some embodiments, referring to FIG. 3 and FIG. 4, at least one selected from a group consisting of the restriction-releasing mechanism 150 and the main unlocking mechanism 130 defines a limiting groove 20.

An end of the second housing 112 is inserted into the first housing 111 and is provided with a limiting portion 1121. The limiting portion 1121 extends into the limiting groove 20. Two groove walls defining the limiting groove 20 match with the limiting portion 1121 to define a travel range of the release-limiting mechanism 150 and/or the main unlocking mechanism 130 that is defined with the limiting groove 20.

In the embodiments, based on the split structure of the housing 110, the structure of the restriction-releasing mechanism 150 and the main unlocking mechanism 130 are optimized. At least one selected from a group consisting of the restriction-releasing mechanism 150 and the main unlocking mechanism 130 defines the limiting groove 20. The limiting groove 20 is arranged along the movement direction of the mechanism, and its shape and dimensions are configured to meet the restriction requirements. One end of the second housing 112 is inserted into the first housing 111, and the inserted end of the second housing 112 is provided with the limiting portion 1121. The limiting portion 1121 has a shape matching the limiting groove 20 such that it can extend into the limiting groove 20. When the second housing 112 is assembled with the first housing 111, the limiting portion 1121 correspondingly extends into the limiting groove 20, and the groove walls at two ends of the limiting groove 20 form a limiting engagement with the limiting portion 1121. This limiting engagement effectively defines the extreme positions of movement of the release-limiting mechanism 150 and/or the main unlocking mechanism 130 that defines the limiting groove 20, ensuring that the release-limiting mechanism 150 and/or the main unlocking mechanism 130 can only move within a predetermined travel range during operation, thereby preventing damage to the mechanism or internal structures caused by excessive pressing, while also ensuring that the mechanism can accurately trigger the corresponding function.

In the embodiments, the limiting engagement formed between the limiting groove 20 and the limiting portion 1121 can precisely define the travel range of the restriction-releasing mechanism 150 and/or the main unlocking mechanism 130, ensuring that each operation of the restriction-releasing mechanism 150 and/or the main unlocking mechanism 130 accurately triggers the corresponding function. For example, during the unlocking process, the restriction-releasing mechanism 150 can precisely push the stop pin to disengage, and the main unlocking mechanism 130 can accurately push the inner shaft 120 to move, thereby preventing unlocking failure or damage to internal structures caused by insufficient or excessive movement of the mechanism. This improves operational reliability and stability, providing photographers with a guarantee for quick and accurate connection and disconnection during shooting.

In some embodiments, referring to FIG. 1, the restriction-releasing mechanism 150 and the main unlocking mechanism 130 are oppositely disposed on the peripheral side of the housing 110. This opposite arrangement results in a symmetrical spatial distribution of the two mechanisms. When a user performs an unlocking operation, the thumb and index finger can naturally be used to respectively control the two mechanisms, allowing for a smooth and comfortable operation with balanced application of force, thereby effectively improving operational efficiency and reducing misoperation caused by inconvenient handling. Moreover, the opposite arrangement provides a certain degree of physical separation between the two mechanisms, reducing the risk that accidental actuation of one mechanism may cause the other to be actuated in tandem. In complex usage environments, such as when a photographer's clothing rubs against the equipment or the equipment experiences impacts during outdoor shooting, the oppositely disposed mechanisms are less likely to be simultaneously affected, further enhancing the anti-misoperation unlocking capability.

In some embodiments, referring to FIG. 1 to FIG. 4, the locking member 10 includes a plurality of ball detents 11 arranged at intervals along a circumferential direction of the insertion portion 110B.

An end of the inner shaft 120 is provided with a pressing truncated cone 120T, and a side surface of the pressing truncated cone 120T forms a contact fit with the plurality of ball detents 11.

In the embodiments, the locking member 10 achieves a reliable connection with the photographic equipment. The locking member 10 includes a plurality of ball detents 11, which are evenly spaced along the circumferential direction of the insertion portion 110B. Each ball detent 11 is installed in a corresponding mounting hole defined in the sidewall of the insertion portion 110B and is capable of rotating freely within the mounting hole. This allows the plurality of ball detents 11 to have good adaptability when engaging with the photographic equipment.

The side surface of the pressing truncated cone 120T has a conical shape and is configured with specific dimensions and angles to form the contact fit with the plurality of ball detents 11. When the inner shaft 120 moves within the sliding cavity 110Q, the side surface of the pressing truncated cone 120T simultaneously increases or decreases the force applied to each ball detent 11, thereby pressing or releasing the ball detents 11 accordingly.

In use, when the anti-misoperation detachable connector 100 is connected to photographic equipment, the insertion portion 110B is inserted into a socket of the photographic equipment. During insertion, the ball detents 11 first contact an inner wall of the socket. Since the ball detents 11 are freely rotatable, they encounter low friction against the internal structure of the photographic equipment and can be smoothly pressed back into the insertion portion 110B. When the insertion portion 110B is fully inserted into the socket and reaches a predetermined position, the side surface of the pressing truncated cone 120T presses the ball detents 11 to be partially out of the side wall of the insertion portion 110B, causing the ball detents 11 to engage in the corresponding grooves defined in the photographic equipment, thereby locking the anti-misoperation detachable connector 100 to the photographic equipment. At this point, the side surface of the pressing truncated cone 120T remains in contact with the ball detents 11, and the restriction mechanism 140 prevents the inner shaft 120 from moving, ensuring that the ball detents 11 do not retract, further stabilizing the connection.

In the operating state, the restriction mechanism 140 restricts the movement of the inner shaft 120. Even if the main unlocking mechanism 130 is accidentally touched, the inner shaft 120 cannot move, the pressing truncated cone 120T maintains a stable contact with the ball detents 11, and the ball detents 11 remain firmly engaged in the corresponding grooves of the photographic equipment, ensuring reliable connection. When unlocking is required, the restriction-releasing mechanism 150 is first pressed to allow the restriction mechanism 140 to release the restriction on the movement of the inner shaft 120. Subsequently, the main unlocking mechanism 130 is pressed to drive the inner shaft 120 to move within the sliding cavity 110Q. As the inner shaft 120 moves, the side surface of the pressing truncated cone 120T gradually releases the ball detents 11, allowing them to move freely. At this point, the anti-misoperation detachable connector 100 can be withdrawn from the socket of the photographic equipment. During this withdrawal process, the ball detents 11 retract into the mounting holes, disengaging from the grooves of the photographic equipment, thereby completing the disconnection operation.

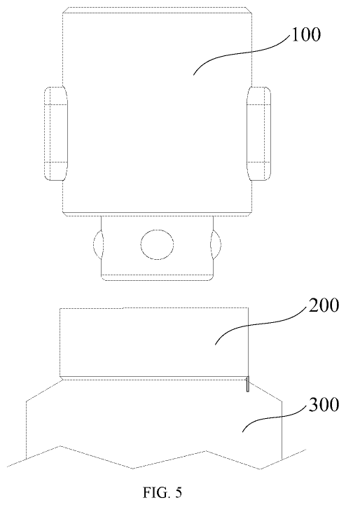

With reference to FIG. 5, the present disclosure further provides a connector assembly, including a connecting connector 200 and the anti-misoperation detachable connector 100 as described in any of the foregoing embodiments. The connecting connector 200 is configured to connect photographic equipment 300, and the anti-misoperation detachable connector 100 is configured to be plugged into and locked with the connecting connector 200. The specific structure of the anti-misoperation detachable connector 100 can refer to the foregoing embodiments. Since the connector assembly adopts all the technical solutions of all the foregoing embodiments, it possesses at least all the technical effects brought about by the technical solutions of the foregoing embodiments, which is not detailed herein. The connector assembly is applied to the connection between photographic devices. For example, a photographic strap is detachably connected to a camera using the connector assembly. The connecting connector 200 is connected to the camera, and the anti-misoperation detachable connector 100 is connected to the photographic strap. By plugging the anti-misoperation detachable connector 100 into and locking it with the connecting connector 200, the camera and the photographic strap are quickly connected. The connecting connector 200 of the connector assembly can be regarded as a female connector, and the anti-misoperation detachable connector 100 can be regarded as a male connector.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. An anti-misoperation detachable connector, configured for connecting photographic equipment, the anti-misoperation detachable connector comprising:
a housing defining a sliding cavity therein, an end of the housing in an axial direction of the housing being provided with an insertion portion for connecting the photographic equipment, and a locking member being provided through a sidewall of the insertion portion;
an inner shaft slidably disposed within the sliding cavity, the inner shaft being configured to move to either press against the locking member or release the locking member;
a main unlocking mechanism movably disposed through a sidewall of the housing, the main unlocking mechanism being configured to press the inner shaft to move for releasing the locking member; and
a safety locking mechanism, comprising:
a restriction-releasing mechanism movably disposed through the sidewall of the housing and spaced apart from the main unlocking mechanism; and
a restriction mechanism, the restriction mechanism being configured to prevent the inner shaft from moving when not actuated by the restriction-releasing mechanism, and to allow the inner shaft to move when actuated by the restriction-releasing mechanism.

2. The anti-misoperation detachable connector of claim 1, wherein,
the restriction mechanism comprises:
a restriction member movably disposed on the inner shaft or movably disposed on the housing; and
a first reset member, configured to act on the restriction member; wherein,
the restriction member moves on its movement path having a restriction position;
the restriction member prevents the inner shaft from moving when the restriction member is in the restriction position, and the restriction member is capable of moving away from the restriction position when actuated by the restriction-releasing mechanism; and
the first reset member is configured to provide a force to the restriction member to reset the restriction member to the restriction position.

3. The anti-misoperation detachable connector of claim 2, wherein,
the sidewall of the housing is defined with a first mounting hole communicated with the sliding cavity, and the restriction-releasing mechanism is mounted in the first mounting hole;
the restriction member is a stop pin, a sidewall of the inner shaft is defined with a sliding hole, and the stop pin is slidably fitted in the sliding hole to be movable relative to the inner shaft; and
the first reset member is a first spring accommodated in the sliding hole and configured to act on the stop pin;
wherein the stop pin extends into the first mounting hole under an elastic force of the first spring to reach the restriction position, or the stop pin retracts from the first mounting hole by being pressed by the restriction-releasing mechanism to leave the restriction position.

4. The anti-misoperation detachable connector of claim 1, wherein,
the sidewall of the housing is defined with a second mounting hole communicated with the sliding cavity, and the main unlocking mechanism is mounted in the second mounting hole;
an end of the main unlocking mechanism extends into the sliding cavity and is provided with a pressing inclined surface, and a sidewall of the inner shaft is provided with a pressed inclined surface, wherein the pressed inclined surface forms a contact fit with the pressing inclined surface; and
the housing is provided with a second reset member configured to provide a force to the inner shaft to reset the inner shaft.

5. The anti-misoperation detachable connector of claim 4, wherein,
the inner shaft is defined with an accommodation hole; and
the second reset member is a second spring, wherein an end of the second spring abuts against a wall of the sliding cavity, and another end of the second spring extends into the accommodation hole and abuts against a bottom wall of the accommodation hole.

6. The anti-misoperation detachable connector of claim 1, wherein,
the housing comprises a first housing and a second housing detachably connected to the first housing; wherein,
the first housing defines a first cavity, the second housing defines a second cavity, and the first cavity and the second cavity cooperatively define the sliding cavity; and
the main unlocking mechanism and the restriction-releasing mechanism are disposed on the first housing, and the insertion portion is arranged on the second housing.

7. The anti-misoperation detachable connector of claim 6, wherein,
at least one selected from a group consisting of the restriction-releasing mechanism and the main unlocking mechanism defines a limiting groove; and
an end of the second housing is inserted into the first housing and is provided with a limiting portion extending into the limiting groove;
wherein two groove walls defining the limiting groove match with the limiting portion to limit a travel range of the restriction-releasing mechanism and/or the main unlocking mechanism that defines the limiting groove.

8. The anti-misoperation detachable connector of claim 1, wherein,
the restriction-releasing mechanism and the main unlocking mechanism are arranged opposite on a circumferential side of the housing.

9. The anti-misoperation detachable connector of claim 2, wherein,
the restriction-releasing mechanism and the main unlocking mechanism are arranged opposite on a circumferential side of the housing.

10. The anti-misoperation detachable connector of claim 3, wherein,
the restriction-releasing mechanism and the main unlocking mechanism are arranged opposite on a circumferential side of the housing.

11. The anti-misoperation detachable connector of claim 4, wherein,
the restriction-releasing mechanism and the main unlocking mechanism are arranged opposite on a circumferential side of the housing.

12. The anti-misoperation detachable connector of claim 5, wherein,
the restriction-releasing mechanism and the main unlocking mechanism are arranged opposite on a circumferential side of the housing.

13. The anti-misoperation detachable connector of claim 6, wherein,
the restriction-releasing mechanism and the main unlocking mechanism are arranged opposite on a circumferential side of the housing.

14. The anti-misoperation detachable connector of claim 1, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

15. The anti-misoperation detachable connector of claim 2, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

16. The anti-misoperation detachable connector of claim 3, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

17. The anti-misoperation detachable connector of claim 4, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

18. The anti-misoperation detachable connector of claim 5, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

19. The anti-misoperation detachable connector of claim 6, wherein,
the locking member comprises a plurality of ball detents that are arranged at intervals along a circumferential direction of the insertion portion; and
an end of the inner shaft is provided with a pressing truncated cone, and a side surface of the pressing truncated cone forms a contact fit with the plurality of ball detents.

20. A connector assembly, comprising a connecting connector and the anti-misoperation detachable connector of claim 1, wherein the connecting connector is configured to connect photographic equipment, and the anti-misoperation detachable connector is configured to be plugged into and locked with the connecting connector.
